(19) United States
(12) Patent Application Publication
(10) Pub. No.: US 2025/0083424 A1
(43) Pub. Date: Mar. 13, 2025

(54) LAMINATE WITH BARRIER PROPERTIES

(71) Applicant: SABIC GLOBAL TECHNOLOGIES B.V., Bergen op Zoom (NL)

(72) Inventors: Jerome Vachon, Maastricht (NL); Peter Neuteboom, Maastricht (NL); Arkadiusz Zych, Gdansk (PL)

(21) Appl. No.: 18/721,320

(22) PCT Filed: Dec. 12, 2022
(86) PCT No.: PCT/EP2022/085287

§ 371 Date: Jun. 18, 2024

(30) Foreign Application Priority Data
Dec. 23, 2021 (EP) 21217320.7

(51) Int. Cl. B32B 27/08; B32B 27/30; B65D 65/40; C08J 5/18; C08J 7/04; C08J 7/048

(52) U.S. Cl. CPC B32B 27/08; B32B 27/308; B65D 65/40; C08J 5/18; C08J 7/042; C08J 7/048; B32B 2250/40; B32B 2255/10; B32B 2255/26; B32B 2307/7244; B32B 2307/7246; B32B 2307/7376; B32B 2439/00; B65D 2565/387; C08J 2323/08; C08J 2483/06

(57) ABSTRACT

The invention relates to a laminate comprising at least one layer a) comprising an oxygen barrier material, at least one layer b) adjacent to layer a), wherein layer b) comprises at least one ethylene-acrylate copolymer comprising recurring units derived from at least one acrylate comonomer represented by formula (I) or (II): CH2=CR1-COO—(CH2)n-OH (I) CH2=CR1-COO—(CH2)m-CHOH—CH2OH (II) wherein R1 is H or C1-C5 linear or branched alkyl, n is an integer of 1-10 and m is an integer of 0-10.

### CROSS REFERENCE TO RELATED APPLICATIONS

This application is a National Stage application of PCT/EP2022/085287, filed Dec. 12, 2022, which claims the benefit of European Application No. 21217320.7, filed Dec. 23, 2021, both of which are incorporated by reference in their entirety herein.

### BACKGROUND

This invention relates to a laminate and its use, for example in packaging of food or pharmaceutical products.

Laminates have been used for many years in connection with packaging of various articles including food products. Laminates suitable for such a use should possess gas-barrier properties, in particular against oxygen, water vapour, carbon dioxide and other gases, which could cause the content of the packaging to deteriorate. Such properties are often provided by laminates having layers comprising barrier materials.

In the manufacturing process of such a laminate, one layer usually serves as a substrate for depositing another layer. However, often a surface modification of the substrate is required before depositing another layer in order to overcome de-wetting effects and poor adhesion in case the materials of the substrate and the depositing layer are not compatible. Commonly, such a substrate is treated for example with plasma prior to the coating. A plasma treatment of the substrate increases surface energy and improves surface adhesion properties. However, this constitutes an additional step in the production of films or laminates, which means as well additional equipment for plasma treatment is necessary. Further to that, an immediate coating with the coating materials is necessary as the functional groups generated by the plasma treatment are only available for a short period of time, usually less than a few days.

### SUMMARY

It is an objective of the present invention to provide a laminate in which above-described and/or other problems are solved, at least in part.

Accordingly, the present invention provides a laminate comprising
at least one layer a) comprising an oxygen barrier material,
at least one layer b) adjacent to layer a), wherein layer b) comprises at least one ethylene-acrylate copolymer comprising recurring units derived from at least one acrylate comonomer represented by formula (I) or (II):

CH2=CR1-COO—(CH2)n-OH (I)

CH2=CR1-COO—(CH2)m-CHOH—CH2OH (II)

wherein R1 is H or C1-C5 linear or branched alkyl, n is an integer of 1-10 and m is an integer of 0-10.

### DETAILED DESCRIPTION

The laminate according to the invention was found to have a good O₂ barrier property.

Preferably, the laminate has as well a good water barrier property. Further, the laminate has good sealability, printability as well as good optical properties, such as low haze and high gloss. In addition, the laminate has a low contact angle.

Layer b) further guarantees satisfactory adhesion to layer a) making it possible to eliminate any preliminary operation to activate layer b).

Further, the laminate according to the invention can be easily prepared. The advantage of the laminate of the present invention is that layer a) is formed directly on layer b) as a substrate without any additional pre-treatment step of layer b), such as plasma treatment.

A laminate according to the invention is defined as a material, which comprises two or more layers, wherein the layers are made of components having a different nature relative to each other and wherein the layers are connected, in particular adhesively bonded, to one another. The layer or layers may be a sheet or sheets. Preferably, at least one layer is a film.

The laminate may comprise at least one layer c) adjacent to b), wherein layer c) comprises a water barrier material.

Preferably, the laminate is a multilayer film.

### Oxygen Barrier Material of Layer a)

Oxygen barrier material is defined here as a material that has an oxygen transmission rate (OTR) in the range from ≥0 to ≤30 cm³·mm/(m²·day·atm), preferably from ≥0 to ≤20 cm³·mm/(m²·day·atm), preferably from ≥0 to ≤18 cm³·mm/(m²·day·atm), preferably from ≥0 to ≤16 cm³·mm/(m²·day·atm), preferably from ≥0 to ≤10 cm³·mm/(m²·day·atm), preferably from ≥0 to ≤5 cm³·mm/(m²·day·atm), preferably from ≥0.5 to ≤5 cm³·mm/(m²·day·atm), most preferably from ≥0.5 to ≤4 cm³·mm/(m²·day·atm), more preferably from ≥0 to ≤1 cm³·mm/(m²·day·atm), most preferably from ≥0 to ≤0.1 cm³·mm/(m²·day·atm) when such material is measured at 23° C. with 0% relative humidity according ISO 15105-2.

Examples of oxygen barrier materials are organic/inorganic hybrid materials, silicium oxide (glass), aluminium oxide, ethylene vinyl alcohols (EVOH), polyamides (PA), polyacrylonitrile (PAN), poly(ethylene naphthalate) (PEN), poly(vinylidene chloride) (PVDC), Cellulose/starch.

Preferably, the oxygen barrier material of layer a) is composed of an organic/inorganic hybrid material. The organic/inorganic hybrid materials are prepared by condensation reactions of an inorganic precursor(s) and an organic compound(s) yielding in organic/inorganic hybrid materials. Thereby the organic functional groups are incorporated into the inorganic network.

The inorganic precursor(s) of the coating composition are metal alkoxides which may be represented by the formula MRn, in which M is a metal atom, preferably Si, Al, Zr or Ti, n is the valency of M and the groups R taken n times each independently represent an alkyl or alkyloxy radical having from 1 to 4 carbon atoms (such as methyl, ethyl, propyl, butyl, methoxy, ethoxy, propoxy, butoxy), provided that at least two of the groups a are alkyloxy radicals. The most preferred metal alkoxide is tetraethoxysilane (TEOS) in which M is silicon (Si), n is 4 and each of the groups R is ethoxy.

The organic compound may be any hydroxyl functionalized polymer. One example is polyvinyl alcohol (PVA). PVA is a polymer obtained from the basic hydrolysis of polyvinyl acetate. Fully hydrolysed PVA (approximately 97-100% of the acetate group hydrolysed) or partially hydrolysed PVA (approximately 86-89% of the acetate groups hydrolysed), both of which are commercially available, may be used.

Another example are ethylene-acrylate copolymers, wherein the acrylate comprises a hydroxyl group. For example an ethylene-acrylate copolymer comprising recurring units derived from at least one acrylate comonomer represented by formula (I) or (II):

CH2=CR1-COO—(CH2)n-OH (I)

CH2=CR1-COO—(CH2)m-CHOH—CH2OH (II)

wherein R1 is H or C1-C5 linear or branched alkyl, n is an integer of 1-10 and m is an integer of 0-10.

The solvent used for the coating composition may be water or a mixture of water and ethyl alcohol, preferably at a v/v ratio between water and ethyl alcohol varying between 100:0 and 70:30. In order catalyse the alkoxide hydrolysis and condensation reaction, the pH of the coating composition is preferably adjusted to slightly acidic values, for instance by adding approximately 0.03 to approximately 1% by weight of hydrochloric acid (HCl).

The hybrid organic/inorganic hybrid material is obtained by the sol-gel process. A sol is a dispersion of solid particles (˜0.1-1 μm) in a liquid where only the Brownian motions suspend the particles. A gel is a state where both liquid and solid are dispersed in each other, which presents a solid network containing liquid components. The sol-gel coating process usually comprises the following steps
(1) Preparation of a sol.
(2) Coating of the substrate by deposition of the sol solution onto the substrate for example by means of spraying, dipping, spinning or any other appropriate conventional technique.
(3) Formation of a gel by condensation reaction.
(4) A final heat treatment cures the remaining organic or inorganic components and form an amorphous or crystalline coating. The heat treatment may advantageously be carried out at relatively low temperatures, preferably between 40° C. and 90° C., more preferably 60° C., for relatively small times, preferably below 5 minutes, for instance for 60 seconds.

The obtained organic/inorganic hybrid materials have combined characteristics of organic and inorganic materials and the final material properties can be tuned between those of the organic and the inorganic material. Usually, the organic phase guarantees tenacity, flexibility, and adhesion to the polymeric substrate and the inorganic one gives toughness and thermal, chemical and flame resistance, as well as improved gas barrier properties.

The organic/inorganic hybrid material has good adhesion, is colourless and provides a layer having excellent gas-barrier properties against nitrogen, carbon dioxide, water vapour and in particular oxygen. The barrier values are maintained at high levels even in conditions of high relative humidity, for instance up to a relative humidity of 75%. Moreover, the barrier layer is preferably transparent. Printing ink and/or a normal adhesive may be applied on it without decrease of the barrier properties. The barrier layer appears completely transparent, colourless and shows no haze phenomena.

The hybrid materials are sometimes referred to as “ceramers,” “ormocers” (organically modified ceramics), or “ormosils” (organically modified silicates).

### Ethylene-Acrylate Copolymer of Layer b)

Ethylene-acrylate copolymer needs to be understood as a copolymer comprising recurring units derived from ethylene and at least one kind of acrylate.

The ethylene-acrylate may comprise recurring units derived from ethylene and two or more kind of acrylates with different chemical structures.

Preferably, the ethylene-acrylate comprises recurring units derived from ethylene and one kind of acrylate.

Preferably, R¹ is H or C1-C2 alkyl, more preferably R¹ is H or C1 alkyl.

The acrylate in the ethylene copolymer may be represented by formula (I). Preferably, n is an integer of 1-5, more preferably 1-3, more preferably 2-3.

In the cases where the acrylate is represented by formula (I), preferred examples of the acrylate include hydroxyethyl methacrylate (R¹ is methyl; n is 2) (HEMA), hydroxyethyl acrylate (R¹ is H; n is 2), hydroxypropyl methacrylate (R¹ is methyl; n is 3), hydroxypropyl acrylate (R¹ is H; n is 3). Most preferred is hydroxyethyl methacrylate (R¹ is methyl; n is 2) (HEMA).

In the cases where the acrylate is represented by formula (II), m is an integer of 1-10, more preferably m is 1-5, more preferably m is 1-2. The presence of two hydroxyl group leads to a higher polarity and an improved oxygen barrier.

In the cases where the acrylate is represented by formula (II), preferred examples of the acrylate include dihydroxypropyl methacrylate (R1 is methyl; m is 1) and dihydroxypropyl acrylate (R1 is H; m is 1).

Preferably, the acrylate is represented by formula (I).

Preferably, the comonomers of the ethylene acrylate copolymer consist of ethylene and the acrylate represented by formula (I) and/or the acrylate represented by formula (II).

Most preferably, the comonomers of the ethylene acrylate copolymer consist of ethylene and the acrylate represented by formula (I).

Preferably, the acrylate is selected from the group consisting of hydroxyethyl methacrylate, hydroxyethyl acrylate, hydroxypropyl methacrylate, hydroxypropyl acrylate, dihydroxypropyl methacrylate or dihydroxypropyl acrylate.

Even more preferably, the comonomers of the ethylene acrylate copolymer consist of ethylene and hydroxyethyl methacrylate.

However, the ethylene acrylate copolymer may comprise one or more further comonomers which are free-radically copolymerizable with ethylene under high pressure, for example 180 MPa or more. Examples of suitable further comomers are α,β-unsaturated C₃-C₈-carboxylic acids, in particular maleic acid, fumaric acid, itaconic acid, acrylic acid, methacrylic acid and crotonic acid, derivatives of α,β-unsaturated C₃-C₈-carboxylic acids, e.g. unsaturated C₃-C₁₅-carboxylic esters, in particular esters of C₁-C₆-alkanols, or anhydrides, in particular methyl methacrylate, ethyl methacrylate, n-butyl methacrylate or tert-butyl methacrylate, methyl acrylate, ethyl acrylate, n-butyl acrylate, 2-ethylhexyl acrylate, tert-butyl acrylate, methacrylic anhydride, maleic anhydride or itaconic anhydride, and 1-olefins such as propene, 1-butene, 1-pentene, 1-hexene, 1-octene or 1-decene. In addition, vinyl carboxylates, particularly preferably vinyl acetate, can be used as comonomers. n-butyl acrylate, acrylic acid or methacrylic acid are particularly advantageously used as comonomer.

In the case of a copolymerization of ethylene, the acrylate (I) and/or (II) and further comonomers, the proportion of the further comonomer or the further comonomers in the reaction mixture is from 1 to 45% by weight, preferably from 3 to 30% by weight, based on the amount of all monomers, i.e. the sum of ethylene and all comonomers. Depending on the type of the further comonomer, it can be preferred to feed the further comonomers at a plurality of different points to the reactor.

Preferably, the amount of units derived from the acrylate in the ethylene-acrylate copolymer of layer b) of the laminate is in the range from ≥4 to ≤12.5 mol %, preferably in the range from ≥7.5 to ≤12.5 mol %. The amount of units derived from the acrylate refers to the total amount of units derived from acrylates, if more than one acrylate was used for the preparation of the copolymer.

The amount of units derived from the acrylate in the above mentioned ranges provides excellent adhesion of the ethylene-acrylate copolymer to layer a) comprising an oxygen barrier material as well as to layer c) comprising an water barrier material. Higher amount of units derived from the acrylate(s) lead to an ethylene-acrylate copolymer that is very sticky and difficult to process.

The amount of units derived from the acrylate in the ethylene-acrylate copolymer can be easily varied by tuning the amount of acrylate in the reactor feed compared to ethylene. Hence, the ethylene-acrylate copolymer properties can be easily adapted to the desired level. For a good adhesion of layer(s) b) to any layer a) and c) an optimal amount of hydroxyl groups is necessary. It is also important that any layer of a) can be applied onto any layer of b) yielding in a uniform thickness of any layer a). This is for example not possible when droplets are formed on the surface of layer a) and do not wet uniformly the surface during the coating process, for example during sol-gel coating.

Preferably, the ethylene-acrylate copolymer according to the present invention has a density of 915 to 1100 kg/m³ according to ISO1183, for example from 925 to 1050 kg/m³.

Preferably, the ethylene acrylate copolymer according to the present invention has a melt flow rate of 0.10 g/10 min to 150 g/10 min according to ISO1133:2011 measured at 190° C. and 2.16 kg, for example from 0.1 to 50 g/10 min, for example from 0.3 to 10 g/10 min, for example from 0.2 to 5 g/10 min, for example from 0.5 to 4 g/10 min.

High pressure reactors for the preparation for LDPE are suitable for the preparation of the ethylene acrylate copolymer of layer b) according to the invention.

An advantage of polymerisation in such high-pressure free-radical process is that the polymerisation may be performed without the need for a catalyst being present. This allows for the use of certain comonomers such as polar comonomers which are not suitable as comonomers in the production of ethylene copolymers via catalytic processes such as using Ziegler-Natta type catalysts because of the interference with such catalyst. A further advantage of preparation of the ethylene copolymers according to the invention in a high-pressure free-radical polymerisation process is that such polymerisation results in ethylene copolymers having a certain degree of long-chain branching.

The high pressure reactors for LDPE can take one of two forms being either an autoclave, with a height-to-diameter ratio in the region of 2-20, or a tubular reactor, with a length-to-diameter ratio from a few hundred up to tens of thousands. These two divergent reactor geometries pose uniquely different chemical engineering problems requiring disparate control conditions. Tubular and autoclave reactors with their disparate profiles require different methods of temperature control. The high pressure reactors for LDPE can alternatively be used in series, where an autoclave and tubular reactor configuration can be combined for the ethylene polymerization reaction.

The autoclave process and the tubular process result in different chain architecture (Tackx and Tacx, Polymer Volume 39, number 14, pp 3109-3113, 1998) and different molecular weight distribution of the polymer (Kaltenbacher, Vol 50, No 1, January 1967, TAPPI). Polymerizing in a tubular reactor has advantages that higher turnovers can be achieved in the polymerization process, the process is easier to scale-up and it is accordingly possible to build “world-scale” plants and the polymerization is in general more economic because of a lower specific consumption of utilities such as electricity and cooling water. On the other hand, for the preparation of LDPE copolymers with very high comonomer content, the use of autoclave reactors is common due to their smaller capacity and near isothermal operation compared to tubular reactors.

The reaction can be optimally controlled by metering different initiators or mixtures of initiators at different initiator injection points. Suitable initiators are well-known. Possible initiators for starting the free-radical polymerization are, for example, air, oxygen, azo compounds or peroxidic polymerization initiators. In general, the concentration of added initiator is less than 200 ppm. Thus, the resulting resins are not greatly contaminated by initiator residues and normally require no purification prior to use. Certain initiator residues can impart an off taste or smell to resins, making them undesirable in food packaging applications.

Additionally, peroxide is typically added together with a peroxide solvent which typically comprises C₂-C₂₀ normal or iso-paraffin. The solutions comprise the initiators or initiator mixtures in proportions of from 2 to 65% by weight, preferably from 5 to 40% by weight and particularly preferably from 10 to 30% by weight.

Such high-pressure free-radical polymerisation process may preferably be performed in a tubular reactor. Such tubular reactor may for example be a reactor such as described in Nexant PERP Report 2013-2, ‘Low Density Polyethylene’, pages 31-48.

Preferably the acrylate (I) and/or (II) is first mixed with ethylene before it is brought into contact with the free-radical polymerization initiator. Such a mixture of ethylene and the acrylate (I) or (II) can be fed as one stream to the inlet of the tubular reactor. It is also possible to feed more than one stream of ethylene and the acrylate (I) or (II) and feed accordingly one or more of these streams as side stream to the tubular reactor.

During the polymerisation it is possible to add inhibitors, scavengers and/or a chain regulator. Chain transfer is the process by which the growth of a polyethylene chain is terminated in such a way that the free radical associated with it transfers to another molecule on which further chain growth occurs. The molecule to which the free radical is transferred can be either ethylene or a deliberately added chain transfer agent (CTA) such as a solvent molecule. Generally, the effect of adding a chain transfer agent is to reduce the average molecular weight of the resin and as a general rule, chain transfer is controlled by altering reaction conditions and by the addition of chain transfer agents.

The preparation of the copolymer is preferably carried out at pressures of from 150 MPa to 350 MPa. The pressures may preferably be 160 MPa to 300 MPa or more preferably 160 MPa to 280 MPa. The temperatures are preferably in the range from 100° C. to 350° C., more preferably from 120° C. to 340° C. and more preferably from 150° C. to 320° C. The tubular reactor may have a tube length of for example ≥1000 m and ≤5000 m. The tubular reactor may for example have a ratio of length to inner diameter of ≥1000:1, alternatively ≥10000:1, alternatively ≥25000:1, such as ≥10000:1 and ≤50000:1, alternatively ≥25000:1 and ≤35000:1. The residence time in the tubular reactor may for example be ≥30 s and ≤300 s, alternatively ≥60 s and ≤200 s. Such tubular reactors may for example have an inner tubular diameter of ≥0.01 m and ≤0.20 m, alternatively ≥0.05 m and ≤0.15 m. The tubular reactor may for example have one or more inlet(s) and one or more outlet(s). The feed composition may for example be fed to the tubular reactor at the inlet of the tubular reactor. The stream that exits the tubular reactor from the outlet may for example comprise the ethylene copolymer. The stream that exits the tubular reactor from the outlet may for example comprise unreacted feed composition. Such unreacted feed compositions may be recycled back into the tubular reactor via one or more inlet.

Water barrier material of layer c) is defined here as a material that has a water vapor transmission rate (WVTR) in the range of ≥0 to ≤10 g·mm/(m²·day·atm), preferably from ≥0 to ≤5 g·mm/(m²·day·atm), preferably from ≥0 to ≤1 g·mm/(m²·day·atm), more preferably from ≥0 to ≤0.5 g·mm/(m²·day·atm), most preferably from ≥0 to ≤0.1 g·mm/(m²·day·atm), when such material is measured at 23° C. with 85% relative humidity according to ISO1506-3. Additionally, it should retain its gas barrier properties when exposed to humidity for a prolonged time. For instance, the OTR of the material should remain ≤20 cm³·mm/(m²·day·atm), when exposed at a higher humidity content and measured at 23° C.

Examples of water barrier materials are silicium oxide (glass), aluminium oxide, polyvinyldichloride (PVDC), polyamide, polyolefins (PE, PP, elastomeric copolymer) and polyethylene terephthalate (PET).

### Polyolefin of Layer c)

The polyolefin is preferably polyethylene, such as linear low density polyethylene (LLDPE), low density polyethylene (LDPE), high density polyethylene (HDPE), or polypropylene or a combination thereof. The polyolefin is preferably LLDPE or LDPE or a combination thereof.

The production processes of LDPE, HDPE and LLDPE are summarised in Handbook of Polyethylene by Andrew Peacock (2000; Dekker; ISBN 0824795466) at pages 43-66.

### LLDPE

The LLDPE may be an ethylene homopolymer or may be an ethylene copolymer comprising ethylene and a C3-C10 alpha-olefin comonomer (ethylene-alpha olefin copolymer). Suitable alpha-olefin co monomers include 1-butene, 1-hexene, 4-methyl pentene and 1-octene. The preferred comonomer is 1-hexene. Preferably, the alpha-olefin comonomer is present in an amount of about 5 to about 20 percent by weight of the ethylene-alpha olefin copolymer, more preferably an amount of from about 7 to about 15 percent by weight of the ethylene-alpha olefin copolymer.

Preferably, the density of the LLDPE may range in the range from 915 to 934 kg/m³, determined according to ISO1183.

Preferably, the melt flow index of the LLDPE ranges from 0.1 to 5.0 g/10 min, for example from 0.5 to 4.0 g/10 min, for example from 1.0 to 3.0 g/10 min, determined according to ASTM D1238 (190° C./2.16 kg).

The technologies suitable for the LLDPE manufacture include but are not limited to gasphase fluidized-bed polymerization, polymerization in solution, and slurry polymerization. According to a preferred embodiment of the present invention the LLDPE has been obtained by gas phase polymerization in the presence of a Ziegler-Natta catalyst. According to another preferred embodiment, the LLDPE may be obtained by gas phase polymerization in the presence of a metallocene catalyst.

### LDPE

The low density polyethylene (LDPE) may be an ethylene homopolymer or may be an ethylene copolymer comprising ethylene and a comonomer for example butene or hexene.

Preferably, the LDPE has a density in the range from 915 to 935 kg/m³, for example from 920 to 928 kg/m³, determined according to ISO1183.

Preferably, the LDPE has a melt flow index of 0.1 to 10.0 g/10 min, more preferably 1.0 to 5.0 g/10 min, determined according to ISO1133:2011 (190° C./2.16 kg), even more preferably ranges from 0.1 to 4 g/10 min, for example from 0.3 to 3 g/10 min, for example from 0.2 to 2 g/10 min, for example from 0.5 to 1.5 g/10 min.

The LDPE may be produced by use of autoclave high pressure technology or by tubular reactor technology.

Suitable examples of the LDPE include SABIC 2102X0.

### HDPE

The HDPE may be an ethylene homopolymer or may be an ethylene copolymer comprising ethylene and a comonomer for example butene or hexene.

Preferably, the HDPE has a density of 940 to 970 kg/m³, more preferably 950 to 965 kg/m³, determined according to ISO1183. Preferably, the density of the HDPE ranges from 940 to 965 kg/m³.

Preferably, the HDPE has a Melt flow index of 0.1 to 15.0 g/10 min, more preferably 0.5 to 10.0 g/10 min, even more preferably 1.0 to 10.0 g/10 min, most preferably 1.0 to 8.0 g/10 min measured according to ASTM D1238 (190° C./5 kg).

Preferably, the melt flow index as determined using ISO1133:2011 (190° C./2.16 kg) ranges from 0.1 to 6 g/10 min, preferably ranges from 0.1 to 4 g/10 min, for example from 0.3 to 3 g/10 min, for example from 0.2 to 2 g/10 min, for example from 0.5 to 1.5 g/10 min.

### Elastomeric Copolymer

The polyethylene may be an elastomeric copolymer of ethylene and an α-olefin having 4 to 10 carbon atoms. The α-olefin comonomer in the elastomeric copolymer is preferably an acyclic monoolefin such as 1-butene, 1-pentene, 1-hexene, 1-octene or 4-methylpentene. Most preferably, the elastomeric copolymer is an ethylene-1-octene copolymer.

Preferably, the elastomeric copolymer has a density of 850 to 910 kg/m³. Preferably, the density of the elastomeric copolymer is 865 to 910 kg/m³, for example 865 to 875 kg/m³ according to ASTM D792.

Preferably, the elastomeric copolymer has a melt flow index of 1.0 to 10.0 g/10 min, for example 3.0 to 8.0 g/10 min, measured in accordance with ASTM D1238 using a 2.16 kg weight and at a temperature of 190° C.

The elastomers may be prepared using methods known in the art, for example by using a single site catalyst, i.e., a catalyst the transition metal components of which is an organometallic compound and at least one ligand of which has a cyclopentadienyl anion structure through which such ligand bond coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the amount of ethylene in the elastomer is at least 50 mol %. More preferably, the amount of ethylene in the elastomer is at least 57 mol %, for example at least 60 mol %, at least 65 mol % or at least 70 mol %. Even more preferably, the amount of ethylene in the elastomer is at least 75 mol %. The amount of ethylene in the elastomer may typically be at most 97.5 mol %, for example at most 95 mol % or at most 90 mol %.

### Polypropylene

With polypropylene as used herein is meant propylene homopolymer or a copolymer of propylene with ethylene and/or an α-olefin, for example an α-olefin chosen from the group of α-olefins having 4 to 10 C-atoms, for example wherein the amount of units derived from ethylene and α-olefin is 1 to 10 wt % based on the total propylene copolymer.

Polypropylene and a copolymer of propylene with ethylene and/or an α-olefin can be made by any known polymerization technique as well as with any known polymerization catalyst system. Regarding the techniques, reference can be given to slurry, solution or gasphase polymerizations; regarding the catalyst system reference can be given to Ziegler-Natta, metallocene or single-site catalyst systems. All are, in themselves, known in the art.

### Additives

The layers of the laminate according to the invention may further comprise optional components different from the previously mentioned components of the composition, such as additives.

The additives may include stabilisers, e.g. heat stabilisers, anti-oxidants, UV stabilizers, colorants, like pigments and dyes; clarifiers; surface tension modifiers; lubricants; flame-retardants; mould-release agents; flow improving agents; plasticizers; anti-static agents; external elastomeric impact modifiers; blowing agents; inorganic fillers such as talc and reinforcing agents; and/or components that enhance interfacial bonding between polymer and filler, such as a maleated polypropylene.

The amount of the additives may e.g. be 0.1 to 5.0 wt %, for example 0.2 to 1.0 wt %, based on the total composition of the layer.

### Laminate/Film

The laminate according to the invention may have a thickness of e.g. 5-500 μm.

The thickness can be determined for example by optical microscopy.

Layer c) may give required mechanical properties to the film.

Preferably layer
a) has a thickness in the range from ≥10 nm to ≤200 μm, preferably in the range from ≥10 nm to ≤5 μm, more preferably in the range from ≥0.5 μm to ≤5 μm, most preferably in the range from ≥0.5 μm to ≤5 μm and/or
b) has a thickness in the range from ≥25 μm to ≤100 μm or in the range from ≥5 μm to ≤25 μm in case at least one layer of c) is present.

The thickness is determined by known microscopy techniques, such as optical microscopy for thicknesses in the μm range or by electron microscopy for thicknesses in the nm range.

Layer a) may for example have a thickness of 0.1 to 5 μm in case of an organic/inorganic hybrid materials. Layer a) may for example have a thickness of 10 to 200 μm in case of an AlOx and SiOx layer. Layer a) may have a thickness of 1 to 5 μm in case of an organic polymer barrier material, such as EVOH.

Preferably the laminate comprises, in this order, layer c), layer b), layer a), layer b), layer c).

The advantage of this structure is that the oxygen barrier layer a) is protected from moisture by the outer water vapor barrier layer c). This include the need of the 2 tie-layers b) in between layer a) and c). This is of particular relevant for retort food packaging where sterilization is done with steam.

### Process for the Preparation of the Laminate

The invention also relates to a process for the preparation of the laminate, comprising the steps of
a) preparing the ethylene-acrylate copolymer by copolymerizing ethylene and at least one acrylate comonomer represented by formula (I) or (II):

CH₂═CR¹—COO—(CH₂)ₙ—OH (I)

CH₂═CR¹—COO—(CH₂)ₘ—CHOH—CH₂OH (II)

wherein R1 is H or C₁-C₅ linear or branched alkyl, n is an integer of 1-10 and m is an integer of 0-10,
in the presence of a free-radical polymerization initiator at pressures in the range of from 150 MPa to 350 MPa and temperatures in the range of from 100° C. to 350° C. and
b) forming the ethylene-acrylate copolymer into a layer b), such as a film or tube.
c) forming a layer a).

Layer a) may be formed by
1) co-extruding an organic polymer with the ethylene-acrylate copolymer to form layer a) and b) or
2) depositing an inorganic coating layer (SiOx, AlOx) on layer b) using Plasma Enhanced Chemical Vapor Deposition (PECVD) process or
3) depositing an hybrid organic/inorganic material on layer b) by sol-gel deposition and curing step as described above.

Step b) of the process may for example be a blown film (co-)extrusion process, a cast extrusion process or compression moulding, for preparation of either a single layer film or a multi-layer film. For the preparation of a single layer or multi-layer tube, blown film (co-)extrusion process or pipe-extrusion process is preferably used.

Multilayer structures may be prepared for example by a blown film co-extrusion process, for example as disclosed in “Film Extrusion Manual”, (TAPPI PRESS, 2005, ISBN 1-59510-075-X, Editor Butler, pages 413-435).

For example, in the process of coextrusion, the various resins may be first melted in separate extruders and then brought together in a feed block. The feed block is a series of flow channels which bring the layers together into a uniform stream. From this feed block, this multilayer material then flows through an adapter and out a film die. The blown film die may be an annular die. The die diameter may be a few centimeters to more than three meters across. The molten plastic is pulled upwards from the die by a pair of nip rolls high above the die (from for example 4 meters to more than 20 meters). Changing the speed of these nip rollers will change the gauge (wall thickness) of the film. Around the die an air-ring may be provided. The air exiting the air-ring cools the film as it travels upwards. In the center of the die there may be an air outlet from which compressed air can be forced into the center of the extruded circular profile, creating a bubble. This expands the extruded circular cross section by some ratio (a multiple of the die diameter). This ratio, called the “blow-up ratio” can be just a few percent to for example more than 300 percent of the original diameter. The nip rolls flatten the bubble into a double layer of film whose width (called the “layflat”) is equal to ½ of the circumference of the bubble. This film may then be spooled or printed on, cut into shapes, and heat sealed into bags or other items.

Heat sealing may for example be done by sealing equipment such as a compression packaging machine as for example disclosed in U.S. Pat. No. 3,753,331.

A further suitable preparation method is casting or cast film extrusion. The preparation of a multilayer film by casting is well-known in the art. The preparation of the multilayer film according to the invention may be done as described in “Handbook of plastic films” (E. M. Abdel-Bary, iSmithers Rapra Publishing, 2003, pages 16-17).

In general, casting is a continuous operation of melting and conveying a polymer in a heated screw-and-barrel assembly. Polymer is extruded through a slit onto a chilled, highly polished turning roll, where it is quenched from one side. Film is sent to a second roller for cooling on the other side. Alternatively, polymer web is passed through a quench tank for cooling. Film then passes through a system of rollers, which have different purposes, and is finally wound onto a roll for storage.

### Articles

The invention further relates to an article comprising the laminate according to the invention. The article may be a multilayer film or sheet, a multilayer pouch, a multilayer tube, a multilayer thermo formed article, a multilayer container, wherein preferably at least one layer is a foamed layer.

Preferably, the article is a packaging article for packaging food or pharmceuticals.

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, preferred in particular are those combinations of features that are present in the claims.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention is now elucidated by way of the following examples, without however being limited thereto.

### Examples

### 1. Preparation of the Ethylene-Acrylate Copolymer

Two polymers PE-HEMA-1 (containing 4 mol % of HEMA) and PE-HEMA-2 (containing 7.5 mol % of HEMA) were prepared in an autoclave reactor operated at a pressure of 200 MPa, The temperature of the reaction mixture was kept constant at 220° C. by means of control of the feed of the peroxide tertiary-butyl peroxypivalate.

### 2. Preparation of the Laminate

“Oxyflav” was obtained from high innovation materials, HMI. Oxyflav is a water-based solution of a hybrid siloxane material combining PVA (polyvinyl alcohol) with a silicium oxide precursor such as TEOS (tetraethoxysilane) according to

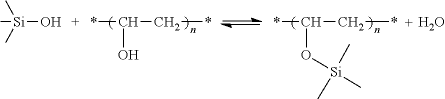

The coating was applied by the wire-bar coating method to a layer of the ethylene-acrylate copolymer, thin layers of sol gel coating Oxyflav were applied. The liquid was placed over the film surface by means of a roll and coated onto the surface of the polyolefin film. Drying/curing of the sol gel material resulted in a thin layer of polysiloxane on the polyolefin surface.

PE-HEMA-1 and PE-HEMA-2 were coated with 1 μm layer of Oxyflav without prior plasma treatment.

### 3. Measurement Methods

Oxygen-barrier properties are typically measured by means of oxygen permeation (OTR) which is expressed in cm³/(m²·day·atm).

The measurements were carried out in an environment of varying relative humidity and temperature, with an oxygen concentration of 21% (ambient concentration), at a pressure of 1 atm and for a period of 12 hours.

A correction can be applied with the thickness of the material, by multiplying the OTR by the thickness in mm. This leads to an OTR expressed in cm³·mm/m²·day·atm.

Parameters for oxygen permeability measurement were
Temperature Set Point: 23.0° C.
Relative Humidity: 2.1% Conditioning: Low
Carrier Flux: 80.2 [ml/min]
No Serial Machine: MultiPerm 050
Condit. Time: OFF 0 [h] Sample area: 2.01 cm²
Comp. Barometric: ON 1002.7 [mbar]

### 4. Results

Oxygen barrier properties were measured at different temperature and relative humidity (RH) according to ISO 15105-2 and results are shown the table below.

| Condition | | | | |
|---|---|---|---|---|
| OTR cm³ · | | | PE-HEMA-1 | PE-HEMA-2 |
| mm/m² · | | | coated with | coated with |
| day · atm | PE-HEMA-1 | PE-HEMA-2 | Oxyflav | Oxyflav |
| 23° C., 0% RH | 96 | 182 | 16 | 4 |
| 23° C., 50% | 97 | — | 20 | — |
| RH | | | | |
| 38° C., 50% | 221 | 310 | 44 | 31 |
| RH | | | | |

The table shows that the PE-HEMA coated laminates show a lower Oxygen Transmission Rate (OTR) than the PE-HEMA film.

PE-HEMA 1 and PE-HEMA 2 display a different Oxygen Transmission Rate (OTR).The OTR of PE-HEMA-1 is half of PE-HEMA-2 with 96 and 182 cm³·mm/(m²·day·atm) respectively. This might be a result of the lower crystallinity of PE-HEMA-2 as a higher HEMA content leads to an overall decrease of polymer's crystallinity. However, this phenomenon is counteracted by the increase of polymer's cohesive energy due to the high amount of OH groups.

For PE-HEMA-1, the Oxyflav coating improved up to 6 times the oxygen barrier properties with an OTR of 16 cm³·mm/(m²·day·atm) (23° C., 0% RH), Relative humidity had little influence on barrier, while increasing both temperature and humidity (38° C. at 50% RH) led to a 3 times increase of OTR with 44 cm³·mm/(m²·day·atm).

The results further indicate that the amount of HEMA in the polymer is important for low OTR. Although PE-HEMA films with higher HEMA content display a higher OTR, this is not reflected in the PE-HEMA coated laminates. Hence, a synergistic effect is observed. A higher HEMA content leads obviously to a better adhesion of the inorganic/organic hybrid layer and as a result to a better OTR performance.

1. Laminate comprising
at least one layer a) comprising an oxygen barrier material,
wherein the oxygen barrier material has an oxygen transmission rate (OTR) in the range from ≥0 to ≤30 cm³/(m²·day·atm) when measured according to ISO 15105-2 at 23° C. and 0% relative humidity.
at least one layer b) adjacent to layer a), wherein layer b) comprises at least one ethylene-acrylate copolymer comprising recurring units derived from at least one acrylate comonomer represented by formula (I) or (II):
CH₂═CR¹—COO—(CH₂)ₙ—OH (I)
CH₂═CR¹—COO—(CH₂)ₘ—CHOH—CH₂OH (II)
wherein R¹ is H or C1-C5 linear or branched alkyl, n is an integer of 1-10 and m is an integer of 0-10.

2. The laminate according to claim 1, comprising at least one layer c) adjacent to b), wherein layer c) comprises a water barrier material, wherein the water barrier material has water vapor transmission rate (WVTR) in the range of ≥0 to ≤10 g·mm/(m²·day·atm), when measured according to ISO 15106-3 at 23° C. with 85% relative humidity.

3. The laminate according to claim 1, wherein layer
a) has a thickness in the range from ≥10 nm to ≤200 μm, and/or
b) has a thickness in the range from ≥25 μm to ≤100 μm or
b) has a thickness in the range from ≥5 μm to ≤25 μm in case at least one layer of c) is present and/or
c) has a thickness in the range from ≥25 to ≤100 μm.

4. The laminate according to claim 1, wherein the acrylate is represented by formula (I).

5. The laminate according to claim 1, wherein the acrylate is selected from the group consisting of hydroxyethyl methacrylate, hydroxyethyl acrylate, hydroxypropyl methacrylate, hydroxypropyl acrylate, dihydroxypropyl methacrylate or dihydroxypropyl acrylate.

6. The laminate according to claim 1, wherein the oxygen barrier material is selected from an inorganic/organic hybrid material.

7. The laminate according to claim 1, wherein the water barrier material is selected from polyethylene terephthalate, polyamide and polyolefin.

8. The laminate according to claim 1, wherein the amount of incorporated acrylate in the ethylene-acrylate copolymer of layer b), is in the range from ≥4 to ≤12.5 mol %.

9. The laminate according to claim 1, wherein the laminate is a film.

10. The laminate according to claim 1, wherein the laminate has an OTR in the range of 0.1-20 cm³·mm/(m²*24 h) at 0% RH and 23° C.

11. The laminate according to claim 1, wherein the laminate comprises, in this order, layer c), layer b), layer a), layer b), layer c).

12. An article comprising the laminate according to claim 1.

13. The article according to claim 12, wherein the article is a multilayer film or sheet, multilayer pouch, multilayer tube, multilayer thermo formed article, multilayer container.

14. A packaging article comprising the laminate according to claim 1.
